(19) United States
(12) Patent Application Publication
(10) Pub. No.: US 2016/0271781 A1
(43) Pub. Date: Sep. 22, 2016

(54) LINEAR RECIPROCATING MOTION DEVICE USING ELECTRIC MOTOR-DRIVEN DRILL

(71) Applicant: KOBAYASHI TOOL MFG. CO., LTD., Niigata (JP)

(72) Inventors: Mitsuharu Kobayashi, Sanjo-shi, Niigata (JP); Makoto Ikarashi, Sanjo-shi, Niigata (JP); Masatsugu Sato, Sanjo-shi, Niigata (JP)

(21) Appl. No.: 14/350,803

(22) PCT Filed: Dec. 5, 2013
(86) PCT No.: PCT/JP2013/082689

§ 371 Date: Apr. 9, 2014

(51) Int. Cl. B25F 3/00; F16H 25/20; B23D 29/00

(52) U.S. Cl. CPC B25F 3/00; B23D 29/002; F16H 25/20

(57) ABSTRACT

A linear reciprocating motion device using an electric motor-driven drill is provided, the device converting the rotation of the electric motor-driven drill to a linear reciprocating motion with a simple structure. The linear reciprocating motion device includes a spindle (30) that can be removably provided to the electric motor-driven drill (20), the spindle including a male screw unit (30a) at an intermediate position, a nut (40) including a female screw unit (40a) to be screwed into the male screw unit, a movable body (41) to be integrally coupled to the nut, a spindle holder (35) to be connected to cover a tip portion of the spindle, a fixing tool (80) having one end engaged with the electric motor-driven drill and another end coupled to the spindle holder, the fixing tool inhibiting the spindle holder and the movable body from rotating together, a first elastic member (61) pressing the female screw unit toward the male screw unit when the male screw unit is positioned closer to the electric motor-driven drill side than the female screw unit, a second elastic member (62) pressing the female screw unit toward the male screw unit when the female screw unit is positioned closer to the electric motor-driven drill side than the male screw unit, a first work unit (51) to be mounted on the movable body, and a second work unit (52) to be mounted on the spindle holder.

### TECHNICAL FIELD

The present invention relates to a device converting the rotation of a hand-held electric motor-driven drill to a linear reciprocating motion and, in particular, to a linear reciprocating motion device capable of cutting an electric wire and providing a compression force onto a subject, with a work unit smoothly making a reciprocating movement.

### BACKGROUND ART

To cut a power line, wire, steel wire, thin steel, or the like (hereinafter referred to as an electric wire), a hand-operated or integrated electric motor-driven cable cutter is used. However, the hand-operated cable cutter requires enormous efforts when cutting an electric wire, particularly with difficulty when the electric wire is thick. On the other hand, while the integrated electric motor-driven cable cutter can cut even a thick electric wire, demerits are such that the device is large and difficult to carry and has high cost.

To address these, a tool has been devised which uses a hand-held electric motor-driven drill that can be easily carried to allow an electric wire, which is difficult to cut with a hand-operated cutter, to be easily cut. Note that since recent electric motor-driven drills can be operated by electric recharging, a power supply can be easily ensured, and usability is more improved.

FIG. 6 is a diagram depicting a conventional example of an electric wire cutting tool using a gear orthogonal to a rotating shaft, viewed from two directions. Also, FIG. 7 is a diagram depicting a conventional example of an electric wire cutting tool using a ball screw. Since these electric wire cutting tools 90 have a structure in which a gear 92 such as a worm gear or bevel gear orthogonal to a rotating shaft 91 is used to rotate a blade unit 93 (refer to Patent Literature 1) and a structure in which a rotating blade 95 is rotated by a processing force of a ball screw 94 (refer to Patent Literature 2), respectively, the rotating shaft 91 can be mounted on an electric motor-driven drill for use.

However, when the tool includes a wheel or the like, the tool tends to be large and heavy. Moreover, amplification of a cutting force by using the principle of leverage leads to a larger tool. Further, since the structure of the tool is complex, the price of the tool itself is disadvantageously increased. Note that a tool for providing a compression force onto a work unit in, for example, crimping a sleeve or the like, swaging a rivet or the like, or drilling, can have a basic mechanism identical to that of the electric wire cutting tool, and therefore has problems similar to those described above.

### CITATION LIST

### Patent Literature

PTL 1: Japanese Unexamined Patent Application Publication No. 2002-160119

PTL 2: Japanese Unexamined Patent Application Publication No. 2004-121585

### SUMMARY OF INVENTION

### Technical Problem

For the electric wire cutting tool using a hand-held electric motor-driven drill and the tool for providing a compression force, easy portability is important, and therefore these tools desirably have a simple structure without using, for example, a gear orthogonal to the rotating shaft of the electric motor-driven drill. Thus, the problems can be solved if the motion of the work unit for cutting or providing a compression force is a simple linear reciprocating motion and the rotation of the electric motor-driven drill can be converted directly to a smooth linear reciprocating motion.

In view of these circumstances, an object of the present invention is to provide a linear reciprocating motion device using an electric motor-driven drill, the device capable of converting the rotation of the electric motor-driven drill to a smooth linear reciprocating motion with a simple structure.

### Solution to Problem

A linear reciprocating motion device using an electric motor-driven drill according to the present invention includes a spindle that can be removably provided to the hand-held electric motor-driven drill, the spindle including a male screw unit at an intermediate position, a nut including a female screw unit to be screwed into the male screw unit, a movable body to be integrally coupled to the nut, a spindle holder to be connected to cover a tip portion of the spindle, a fixing tool having one end engaged with the electric motor-driven drill and another end coupled to the spindle holder, the fixing tool inhibiting the spindle holder and the movable body from rotating together when the spindle rotates, a first elastic member pressing the female screw unit toward the male screw unit when the male screw unit is positioned closer to the electric motor-driven drill side than the female screw unit, a second elastic member pressing the female screw unit toward the male screw unit when the female screw unit is positioned closer to the electric motor-driven drill side than the male screw unit, a first work unit to be mounted on the movable body, and a second work unit to be mounted on the spindle holder, wherein when the electric motor-driven drill is operated, the male screw unit and the female screw unit are screwed into each other to cause the movable body to make a rectilinear motion along the spindle, and when the movable body makes the rectilinear motion to a position where the male screw unit and the female screw unit are unscrewed, the female screw unit is pressed toward the male screw unit by the first elastic member or the second elastic member to cause the male screw unit and the female screw unit to be screwed again when a rotating direction of the electric motor-driven drill is reversed and to cause the movable body to make a rectilinear motion in a reverse direction.

Here, preferably, the nut has a substantially cylindrical shape having the female screw unit at an intermediate position, the device has a first guide roller shaped in a ring and interposed between the first elastic member and the female screw unit and a second guide roller shaped in a ring and interposed between the second elastic member and the female screw unit, and the first and second guide rollers are in contact with the spindle inside the rings and in contact with an inner surface of the nut outside the rings to make axes of the spindle and the nut identical.

Furthermore, the first and second work units may be blade units and, with the first work unit approaching the second work unit, a subject interposed between the first work unit and the second work unit may be cut, or a compression force may be provided to a subject interposed between the first work unit and the second work unit.

### Advantageous Effect of Invention

According to the present invention, an effect is achieved in which the rotation of the electric motor-driven drill can be converted to a linear reciprocating motion with a simple structure and also the work units can be caused to smoothly make a reciprocating movement. Also, by using the linear reciprocating motion, an electric wire that is difficult to cut by a hand-operated tool can be easily cut.

### BRIEF DESCRIPTION OF DRAWINGS

FIG. 1 is an overall view of an electric wire cutting tool, (a) depicting a state in which work units are opened and (b) depicting a state in which the work units are closed;

FIG. 2 is a top view of the electric wire cutting tool when the work units are opened;

FIG. 3 is an overall view of a spindle;

FIG. 4 is a sectional view of a nut;

FIG. 5 is a diagram for describing an internal structure of the electric wire cutting tool, (a) depicting a state in which the work units are opened and (b) depicting a state in which the work units are closed;

FIG. 6 is a diagram depicting a conventional example of an electric wire cutting tool using a gear orthogonal to a rotating shaft, viewed from two directions; and

FIG. 7 is a diagram depicting a conventional example of an electric wire cutting tool using a ball screw.

### DESCRIPTION OF EMBODIMENTS

An embodiment of the present invention is described below with reference to the attached drawings. Here, as an example, description is made by using an electric wire cutting tool with work units of a linear reciprocating motion device being blade units. Note that the linear reciprocating motion device may be used, if the work units are replaced by other members, as a tool for providing a compression force onto a subject interposed between the work units in, for example, crimping a sleeve or the like or swaging a rivet or the like. Furthermore, since a method of mounting each member described in the example is merely an example, a method other than the one described may be used for mounting as long as the mechanism is within the same range.

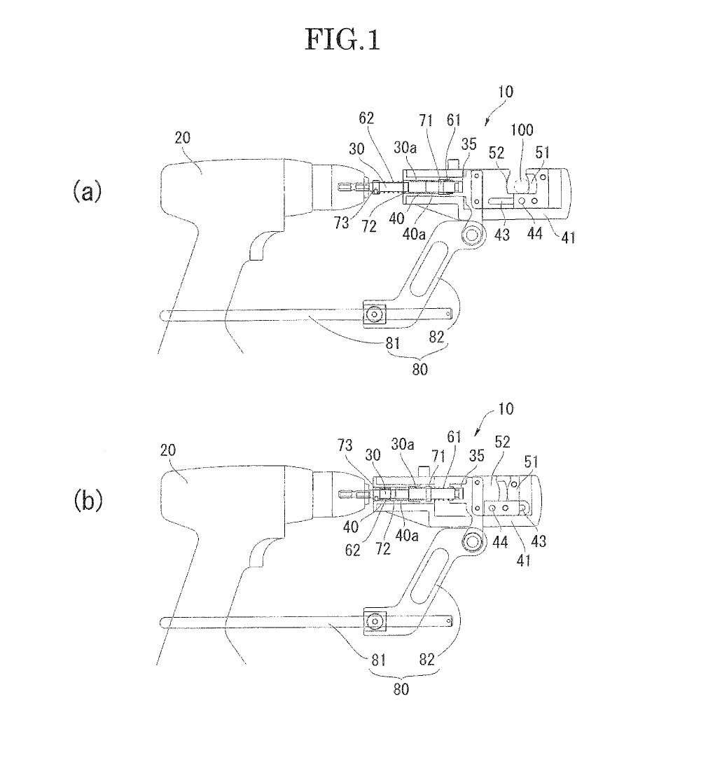

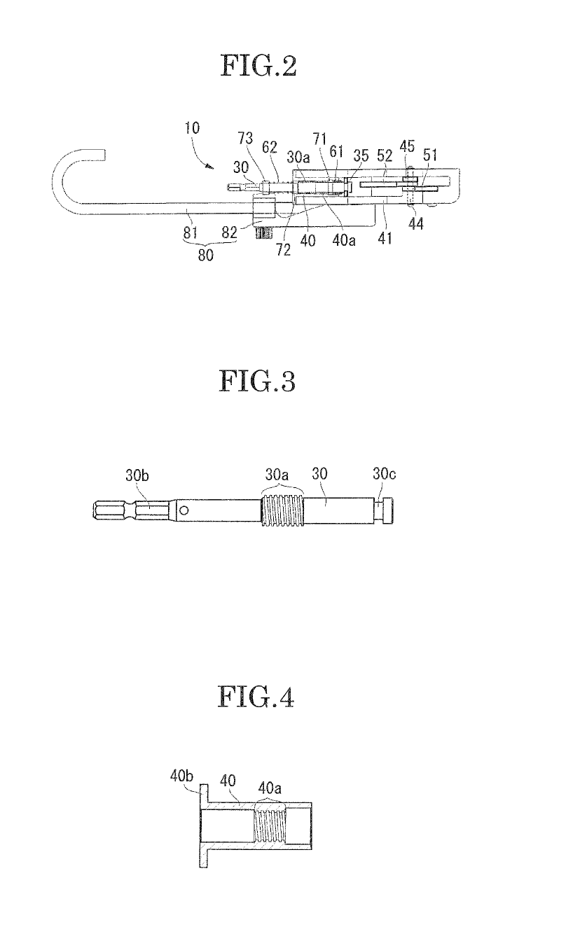

FIG. 1 is an overall view of an electric wire cutting tool, (a) depicting a state in which work units are opened and (b) depicting a state in which the work units are closed. FIG. 2 is a top view of the electric wire cutting tool when the work units are opened. Note that these views are partially sectional views for the purpose of description of an internal structure.

This electric wire cutting tool 10 is used as being mounted on a hand-held electric motor-driven drill 20. As a mechanism of the electric wire cutting tool 10, rotation by the electric motor-driven drill 20 is converted to a rectilinear motion by using screwing of screws, and an electric wire 100 is cut as being interposed between a first work unit 51 movable by that rectilinear motion and a second work unit 52 fixed in position. Note that the electric wire 100 is assumed to be a power line, wire, steel wire, thin steel, or the like.

The electric wire cutting tool 10 has a spindle 30 that can be removably provided to a chuck of the electric motor-driven drill 20. FIG. 3 is an overall view of the spindle. The spindle 30 has an elongated, substantially-columnar shape, and has a male screw unit 30a near an intermediate position. Also, one end is a chuck fixing unit 30b to be mounted on the chuck of the electric motor-driven drill 20. Near the tip of the other end, a groove portion 30c is provided along a circumferential direction of the columnar shape.

To the tip portion of the spindle 30, a spindle holder 35 is connected to cover the tip portion. To that spindle holder 35, the second work unit 52 is connected. A connecting portion between the spindle holder 35 and the spindle 30 is engaged in the groove portion 30c by using a pin or the like. Also, when a compression force is exerted on the second work unit 52 during cutting of the electric wire, the tip face of the spindle 30 is in contact with the spindle holder 35 to receive the compression force.

FIG. 4 is a sectional view of a nut. A nut 40 has a substantially cylindrical shape allowing insertion of the spindle 30, and has a female screw unit 40a near an intermediate position inside the cylinder, the female screw unit 40a screwable into the male screw unit 30a of the spindle 30. Also, the inner surface of the cylinder other than the female screw unit 40a is smooth. When this nut 40 is supported so as not to rotate and the electric motor-driven drill 20 is operated at a position where the male screw unit 30a of the spindle 30 and the female screw unit 40a of the nut 40 are screwed into each other, the nut 40 moves in an axial direction of the spindle 30 by the action of the screws.

Here, the moving direction of the nut 40 is determined by the rotating direction of the electric motor-driven drill 20. Also, the moving distance depends on the length where the male screw unit 30a and the female screw unit 40a are screwed into each other. That is, in the case of the electric wire cutting tool 10, the lengths of the male screw unit 30a and the female screw unit 40a are determined in consideration of the moving distance allowing the work units 51 and 52 to interpose the electric wire 100 for cutting.

Since the nut 40 is coupled to a movable body 41 to move integrally, description hereinafter is made by assuming that the nut 40 is included in the movable body 41. Note that in the present example, the nut 40 and the movable body 41 are coupled together by using a flange unit 40b of the nut 40 with a screw or the like. Also, since the first work unit 51 is connected to the movable body 41, when the movable body 41 makes a rectilinear motion, the first work unit 51 also makes a rectilinear motion.

For the movable body 41 to move in an axial direction of the spindle 30, the movable body 41 is prevented from rotating in conjunction with the rotation of the spindle 30. Also, since the electric wire 100 cannot be cut unless the first and second work units 51 and 52 are linearly opened and closed, the spindle holder 35 connected to the second work unit 52 is also prevented from rotating. To inhibit the spindle holder 35 and the movable body 41 from rotating in conjunction with the rotation of the spindle 30, a fixing tool 80 is provided. The fixing tool 80 has one end connected to the spindle holder 35 and the other end engaged with a hand-held portion of the electric motor-driven drill 20. With this, the rotation of the spindle holder 35 is inhibited. Here, the fixing tool 80 is made so as to have a structure of simultaneously inhibiting a rotating motion of the movable body 41. As an example, as depicted in the top view of FIG. 2, the movable body 41 is configured to nip the spindle holder 35. Therefore, when the rotation of the spindle holder 35 is inhibited, the movable body 41 is also in a state of being inhibited from making a rotating motion.

As an example of the fixing tool 80, a portion to be engaged with the electric motor-driven drill 20 is taken as a fixing rod 81, and a member linking the fixing rod 81 and the spindle holder 35 is taken as an arm 82. The fixing rod 81 has a J shape like a handle of an umbrella as depicted in FIG. 2, and can be hooked over the hand-held portion of the electric motor-driven drill 20. In addition, to allow application to the electric motor-driven drill 20 of any of variety of sizes, a coupling portion between the fixing rod 81 and the arm 82 is configured so as to allow adjustment of the length of the fixing rod 81. Also, a coupling portion between the spindle holder 35 and the arm 82 is configured to be able to rotate by taking a lateral direction of the electric motor-driven drill 20 as an axis.

In the electric wire cutting tool 10, the work units 51 and 52 are blade units. And, the first work unit 51 to be mounted on the movable body 41 is a movable blade, and the second work unit 52 to be mounted on the spindle holder 35 is a fixed blade. Here, a guide is required to be provided so as to allow the movable blade 51 to be linearly opened and closed with respect to the fixed blade 52. As an example, a long hole 43 is provided to the fixed blade 52 as a guide, and a shaft rod 44 movable along this long hole 43 is provided so as to penetrate through the movable body 41 and the movable blade 51.

To cut with great sharpness, the fixed blade 52 and the movable blade 51 have to slide without a gap. Therefore, the structure is such that the fixed blade 52 and the movable blade 51 are pressed by the shaft rod 44 so as to be in intimate contact with each other. Here, while the shaft rod 44 is configured to externally exert a contact pressure on the fixed blade 52, the movable blade 51, and the movable body 41 in a stack, an annular spacer 45 may be interposed to adjust the thickness. Note that by interposing the spacer 45, a function of reducing friction can be achieved.

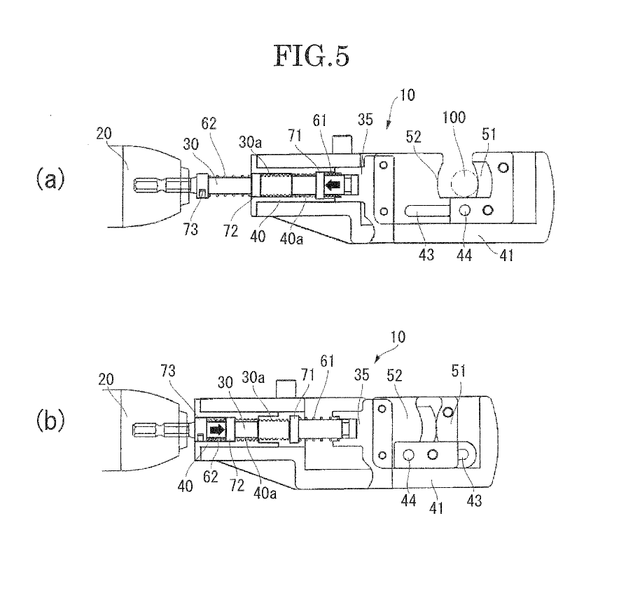

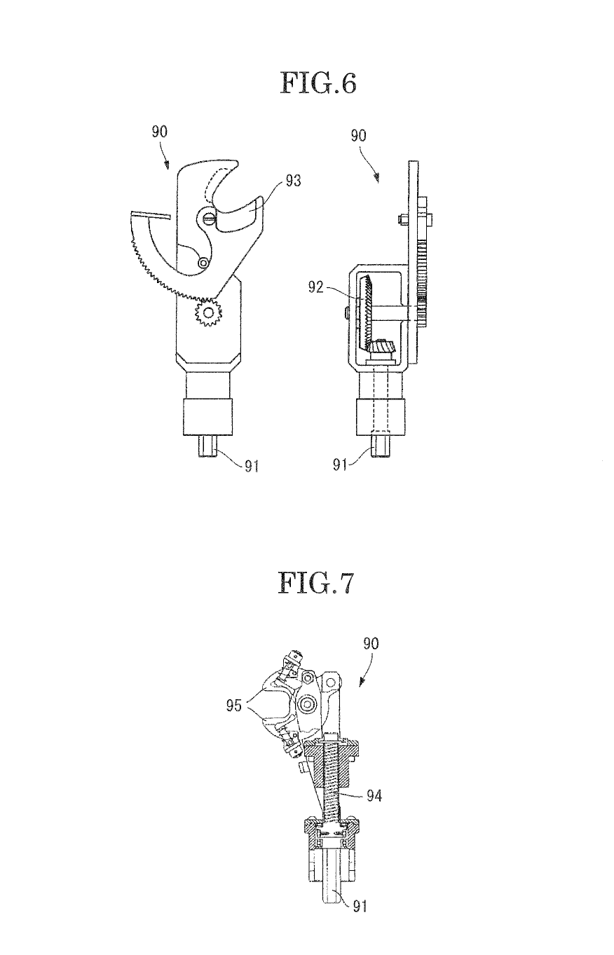

Next, the internal structure of the electric wire cutting tool 10 is described in detail. FIG. 5 is a diagram for describing the internal structure of the electric wire cutting tool, (a) depicting a state in which the work units are opened and (b) depicting a state in which the work units are closed.

With the male screw unit 30a and the female screw unit 40a screwed into each other, the rotating direction is reversed by a switch of the electric motor-driven drill 20, thereby allowing the moving direction of the movable body 41 to be reversed for reciprocating movement. However, when the movable body 41 is moved to a position where the male screw unit 30a and the female screw unit 40a are unscrewed, the spindle 30 idles to stop the rectilinear motion of the movable body 41. At this time, there is a problem in which, with the male screw unit 30a and the female screw unit 40a unscrewed, screwing cannot be immediately made even if the rotation of the electric motor-driven drill 20 is reversed to move the movable body 41 in a reverse direction.

To solve this problem, as depicted in FIG. 5(a), a first elastic member 61 is provided which presses the female screw unit 40a toward the male screw unit 30a when the male screw unit 30a is positioned closer to an electric motor-driven drill 20 side than the female screw unit 40a. Also, as depicted in FIG. 5(b), a second elastic member 62 is provided which presses the female screw unit 40a toward the male screw unit 30a when the female screw unit 40a is positioned closer to an electric motor-driven drill 20 side than the male screw unit 30a. Note that since coil springs with a large expansion/contraction amount are mainly used as these first and second elastic members 61 and 62, these are hereinafter referred to as first and second springs 61 and 62 for description.

By providing these first and second springs 61 and 62, the female screw unit 40a is pressed toward the male screw unit 30a by a pressing force of either of the springs in an unscrewed state. Therefore, when the rotation of the electric motor-driven drill 20 is reversed, the male screw unit 30a and the female screw unit 40a are screwed into each other again to allow the movable body 41 to immediately make a rectilinear motion in a reverse direction. Furthermore, chamfering is preferably provided in front and rear of each threading portion so as to allow the male screw unit 30a and the female screw unit 40a to be easily screwed into each other.

Also, first and second guide rollers 71 and 72 are preferably provided to the first and second springs 61 and 62, respectively, each on a female screw unit 40a side. As an example, with the work units opened as depicted in FIG. 5(a), the first spring 61 is in a state of being compressed by the spindle holder 35 and the first guide roller 71, and the female screw unit 40a is pressed toward the male screw unit 30a via the first guide roller. On the other hand, with the work units closed as depicted in FIG. 5(b), the second spring 62 is in a state of being compressed by a fastening ring 73 mounted on the spindle 30 and the second guide roller 72, and the female screw unit 40a is pressed toward the male screw unit 30a via the second guide roller 72.

The first and second guide rollers 71 and 72 each have a ring shape, the inner side of the ring makes contact with the spindle 30, and the outer side of the ring makes contact with a smooth inner surface of the nut 40, thereby keeping the axes of the spindle 30 and the nut 40 identical. With this, the axis of the male screw unit 30a of the spindle 30 and the axis of the female screw unit 40a of the nut 40 are identical to each other, and therefore smooth screwing can be achieved when the spindle 30 idles and then reversely rotates. Also, the guide rollers 71 and 72 act as plain bearings which intervene between the spindle 30 and the nut 40, thereby also playing a role of preventing energy loss due to friction and suppressing heat generation.

The electric wire cutting tool using the above-structured linear reciprocating motion device can achieve conversion of the rotation of the electric motor-driven drill to a linear reciprocating motion with a simple structure, and also can achieve a smooth reciprocating movement of the work units.

### REFERENCE SIGNS LIST

10 electric wire cutting device
20 electric motor-driven drill
30 spindle
30a male screw unit
30b chuck fixing unit
30c groove portion
35 spindle holder
40 nut
40a female screw unit
41 movable body
43 long hole
44 shaft rod
45 spacer
51 first work unit (movable blade)
52 second work unit (fixed blade)
61 first elastic member (spring)
62 second elastic member (spring)
71 first guide roller
72 second guide roller
73 fastening ring
80 fixing tool
81 fixing rod
82 arm
100 electric wire

1. A linear reciprocating motion device using an electric motor-driven drill, the device comprising:
a spindle that can be removably provided to the hand-held electric motor-driven drill, the spindle including a male screw unit at an intermediate position;
a nut including a female screw unit to be screwed into the male screw unit;
a movable body to be integrally coupled to the nut;
a spindle holder to be connected to cover a tip portion of the spindle;
a fixing tool having one end engaged with the electric motor-driven drill and another end coupled to the spindle holder, the fixing tool inhibiting the spindle holder and the movable body from rotating together when the spindle rotates;
a first elastic member pressing the female screw unit toward the male screw unit when the male screw unit is positioned closer to the electric motor-driven drill side than the female screw unit;
a second elastic member pressing the female screw unit toward the male screw unit when the female screw unit is positioned closer to the electric motor-driven drill side than the male screw unit;
a first work unit to be mounted on the movable body; and
a second work unit to be mounted on the spindle holder, wherein
when the electric motor-driven drill is operated, the male screw unit and the female screw unit are screwed into each other to cause the movable body to make a rectilinear motion along the spindle, and
when the movable body makes the rectilinear motion to a position where the male screw unit and the female screw unit are unscrewed, the female screw unit is pressed toward the male screw unit by the first elastic member or the second elastic member to cause the male screw unit and the female screw unit to be screwed again when a rotating direction of the electric motor-driven drill is reversed and to cause the movable body to make a rectilinear motion in a reverse direction.

2. The linear reciprocating motion device using the electric motor-driven drill according to claim 1, wherein
the nut has a substantially cylindrical shape having the female screw unit at an intermediate position,
the device has a first guide roller shaped in a ring and interposed between the first elastic member and the female screw unit and
a second guide roller shaped in a ring and interposed between the second elastic member and the female screw unit, and
the first and second guide rollers are in contact with the spindle inside the rings and in contact with an inner surface of the nut outside the rings to make axes of the spindle and the nut identical.

3. The linear reciprocating motion device using the electric motor-driven drill according to claim 1, wherein
the first and second work units are blade units and, with the first work unit approaching the second work unit, a subject interposed between the first work unit and the second work unit is cut.

4. The linear reciprocating motion device using the electric motor-driven drill according to claim 1, wherein
with the first work unit approaching the second work unit, a compression force is provided to a subject interposed between the first work unit and the second work unit.
